(19) United States
(12) Patent Application Publication
(10) Pub. No.: US 2009/0110889 A1
(43) Pub. Date: Apr. 30, 2009

(54) CONDUCTIVE PATTERN FORMATION INK, CONDUCTIVE PATTERN AND WIRING SUBSTRATE

(75) Inventor: Naoyuki TOYODA, Suwa (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/254,915

(22) Filed: Oct. 21, 2008

(30) Foreign Application Priority Data
Oct. 30, 2007 (JP) 2007-282345

(51) Int. Cl. B32B 5/16; C09D 11/00; H01B 1/02

(52) U.S. Cl. 428/206; 106/31.92; 252/500

(57) ABSTRACT

A conductive pattern formation ink capable of forming a conductive pattern while preventing occurrence of disconnection thereof due to thermal expansion of a ceramic molded body, a conductive pattern having high reliability, and a wiring substrate provided with the conductive pattern and having high reliability are provided. The conductive pattern formation ink is used for forming a conductive pattern on a ceramic sintered body, wherein the ceramic sintered body with the conductive pattern is produced by the steps of applying the ink onto a ceramic molded body to obtain a pre-pattern on the ceramic molded body, and subjecting the ceramic molded body with the pre-pattern to a degreasing and sintering treatment. The ink contains a water-based dispersion medium, metal particles dispersed in the water-based dispersion medium, and a disconnection preventive agent composed of an organic matter and contained in the water-based dispersion medium, the disconnection preventive agent having a function of providing such a property that the pre-pattern can be deformed according to thermal expansion of the ceramic molded body due to the degreasing and sintering treatment to the pre-pattern, to thereby prevent occurrence of disconnection of the conductive pattern.

### CROSS-REFERENCE TO RELATED APPLICATION

This application claims a priority to Japanese Patent Application No. 2007-282345 filed on Oct. 30, 2007 which is hereby expressly incorporated by reference herein in its entirety.

### BACKGROUND

1. Technical Field

The present invention relates to a conductive pattern formation ink, a conductive pattern and a wiring substrate, and more specially relates to a conductive pattern formation ink, a conductive pattern formed by the conductive pattern formation ink and a wiring substrate provided with the conductive pattern.

2. Related Art

A ceramic circuit substrate including a substrate (ceramic substrate) formed of a ceramic material and a wiring formed of a metal material and provided on the substrate has been widely used as a circuit substrate (wiring substrate) on which electronic parts are to be mounted.

In such a ceramic circuit substrate, the substrate (ceramic substrate) itself is formed of a multifunctional material such as the ceramic material. Therefore, there are merits in that if the ceramic circuit substrate is formed into a multilayer substrate having a plurality of ceramic layers, inner layer parts can be formed easily between the ceramic layers, and in that the ceramic circuit substrate can be produced with high dimensional accuracy.

The above ceramic circuit substrate can be produced by applying a composition containing metal particles onto a ceramic molded body made of a material containing ceramic particles and a binder in a predetermined pattern corresponding to that of a wiring (conductive pattern) to be formed, and then subjecting the ceramic molded body on which the composition is applied to a degreasing and sintering treatment.

A screen printing method has been widely used as a method of forming a pattern on such a ceramic molded body. On the other hand, recently, miniaturization of the wiring and reduction of pitches between the wirings are required for densification of the circuit substrate. However, use of the screen printing method has a disadvantage for miniaturization of the wiring and reduction of pitches between the wirings. As a result, it is difficult to respond to the above requirements by the screen printing method due to the disadvantage.

For this reason, recently, as an alternative method of forming a pattern on the ceramic molded body, there has been proposed use of what is called an ink jet method, i.e., a liquid droplet ejecting method by which a liquid material (conductive pattern formation ink) containing metal particles is ejected in the form of liquid droplets from a liquid droplet ejection head, (see, e.g., JP-A-2007-84387).

However, in the case where a conventional conductive pattern formation ink is used in the ink jet method, there is a problem in that when the ceramic molded body is subjected to the degreasing and sintering treatment, disconnection occurs in a part of the formed conductive pattern due to thermal expansion of the ceramic molded body. The densification of the circuit substrate is progressed by further miniaturizing the wiring and reducing pitches between the wirings, and therefore such a problem becomes serious.

### SUMMARY

It is an object of the present invention to provide a conductive pattern formation ink capable of forming a conductive pattern while preventing occurrence of disconnection thereof due to thermal expansion of a ceramic molded body, a conductive pattern having high reliability, and a wiring substrate provided with the conductive pattern and having high reliability.

With this object in mind, a first aspect of the present invention is directed to a conductive pattern formation ink on a sheet-like ceramic sintered body, wherein the ceramic sintered body with the conductive pattern is produced by the steps of applying the ink onto a sheet-like ceramic molded body made of a material containing ceramic particles and a binder, which will be transformed into the ceramic sintered body, to obtain a pre-pattern which will be transformed into the conductive pattern on the ceramic molded body, and subjecting the ceramic molded body with the pre-pattern to a degreasing and sintering treatment so that the ceramic molded body is transformed into the ceramic sintered body and the pre-pattern is transformed into the conductive pattern.

The conductive pattern formation ink comprises a water-based dispersion medium, metal particles dispersed in the water-based dispersion medium, and a disconnection preventive agent composed of an organic matter and contained in the water-based dispersion medium, the disconnection preventive agent having a function of providing such a property that the pre-pattern can be deformed according to thermal expansion of the ceramic molded body due to the degreasing and sintering treatment to the pre-pattern, to thereby prevent occurrence of disconnection of the conductive pattern.

This makes it possible to provide a conductive pattern formation ink capable of forming a conductive pattern reliably while preventing occurrence of disconnection thereof due to thermal expansion of the ceramic molded body.

In the conductive pattern formation ink of the present invention, it is preferred that in the case where a thermal decomposition starting temperature of the organic matter is defined as T₁ [° C.] and a thermal decomposition starting temperature of the binder is defined as T₂ [° C.], the T₁ and T₂ satisfy a relation of −150≦T₁−T₂≦50.

This makes it possible to prevent the occurrence of the disconnection of the conductive pattern due to the thermal expansion of the ceramic molded body more reliably. As a result, it is possible to further improve an electrical property thereof.

In the conductive pattern formation ink of the present invention, it is preferred that the organic matter comprises a polyglycerin compound having a polyglycerin chemical structure.

This makes it possible to more effectively prevent the occurrence of the disconnection of the conductive pattern due to the thermal expansion of the ceramic molded body.

In the conductive pattern formation ink of the present invention, it is preferred that a weight average molecular weight of the polyglycerin compound is in the range of 300 to 3000.

This makes it possible to further effectively prevent the occurrence of the disconnection of the conductive pattern due to the thermal expansion of the ceramic molded body.

In the conductive pattern formation ink of the present invention, it is preferred that an amount of the organic matter contained in the ink is in the range of 7 to 30 wt %.

This makes it possible to more reliably prevent the occurrence of the disconnection of the conductive pattern due to the thermal expansion of the ceramic molded body.

In the conductive pattern formation ink of the present invention, it is preferred that the pre-pattern is formed using a liquid droplet ejecting method.

This makes it possible to form a fine and complex conductive pattern in a simple and easy manner.

A second aspect of the present invention is directed to a conductive pattern formed by the above conductive pattern formation ink.

This makes it possible to provide a conductive pattern having high reliability.

A third aspect of the present invention is directed to a wiring substrate provided with the above conductive pattern.

This makes it possible to provide a wiring substrate having high reliability.

### BRIEF DESCRIPTION OF THE DRAWINGS

FIG. 1 is a longitudinal section view showing one example of the wiring substrate according to the present invention, that is, a ceramic circuit substrate.

FIG. 2 is an explanatory view schematically illustrating the steps of a method of producing the wiring substrate shown in FIG. 1, that is, the ceramic circuit substrate.

FIGS. 3A and 3B are views for explaining a production process of the wiring substrate shown in FIG. 1, that is, the ceramic circuit substrate.

FIG. 4 is a perspective view showing a schematic configuration of an ink jet apparatus.

FIG. 5 is a pattern diagram for explaining a schematic configuration of an ink jet head.

### DESCRIPTION OF EXEMPLARY EMBODIMENTS

Embodiments of the present invention will be described in detail with reference to the accompanying drawings.

Conductive Pattern Formation Ink

The conductive pattern formation ink of the present invention is an ink for forming a conductive pattern by applying it onto a ceramic molded body made of a material containing ceramic particles and a binder.

More specifically, the conductive pattern formation ink is used for forming a conductive pattern on a sheet-like ceramic sintered body. Here, the ceramic sintered body with the conductive pattern is produced by the steps of applying the ink onto a sheet-like ceramic molded body made of a material containing ceramic particles and a binder, which will be transformed into the ceramic sintered body, to obtain a pre-pattern which will be transformed into the conductive pattern on the ceramic molded body, and subjecting the ceramic molded body with the pre-pattern to a degreasing and sintering treatment so that the ceramic molded body is transformed into the ceramic sintered body and the pre-pattern is transformed into the conductive pattern.

Hereinafter, description will be made on a preferred embodiment of a conductive pattern formation ink. In this embodiment, description will be representatively offered regarding a case that a colloid solution including silver colloid particles (metal colloid particles) dispersed therein is used as a dispersion solution in which metal particles are dispersed in a water-based dispersion medium.

The conductive pattern formation ink (hereinafter simply referred to as ink on occasion) of this embodiment is comprised of a colloid solution containing a water-based dispersion medium, silver colloid particles dispersed in the water-based dispersion medium and a disconnection preventive agent for preventing occurrence of disconnection of the conductive pattern.

Water-Based Dispersion Medium

First, description will be made on the water-based dispersion medium. In this embodiment, the term “water-based dispersion medium” means a liquid constituted from water and/or a liquid having good compatibility with water (that is, a liquid having solubility of 30 g or higher with respect to water of 100 g at 25° C.).

As described above, the water-based dispersion medium is constituted from water and/or a liquid having good compatibility with water, but it is preferred that the water-based dispersion medium is mainly constituted from water. In this regard, an amount of the water contained in the water-based dispersion medium is preferably 70 wt % or more, and more preferably 90 wt % or more.

Examples of such a water-based dispersion medium include water; an alcohol-based solvent such as methanol, ethanol, butanol, propanol or isopropanol; an ether-based solvent such as 1,4-dioxane or tetrahydrofuran (THF); an aromatic heterocyclic compound-based solvent such as pyridine, pyrazine or pyrrole; an amide-based solvent such as N,N-dimethylformamide (DMF) or N,N-dimethylacetamide (DMA); a nitrile-based solvent such as acetonitrile; an aldehyde-based solvent such as acetaldehyde; and the like, one or more of which may be used independently or in combination.

Silver Colloid Particles

Next, description will be made on the silver colloid particles. The term “silver colloid particles” means silver particles each adsorbing (or carrying) a dispersant on a surface thereof.

It is preferred that the dispersant is formed of a hydroxy acid or a salt thereof having three or more COOH and OH groups in a total number, wherein the number of the COOH groups is equal to or greater than the number of the OH group(s). The dispersant is adsorbed to surfaces of the silver particles to form the silver colloid particles.

The dispersant acts to stabilize the colloid solution by allowing the silver colloid particles to be uniformly dispersed in the water-based dispersion medium (colloid solution) under electrical repulsion forces of the COOH groups present in the dispersant.

If the total number of the COOH and OH groups contained in the dispersant is less than three, or if the number of the COOH groups is smaller than the number of the OH groups, there is a case that dispersibility of the silver colloid particles cannot be obtained sufficiently.

Examples of the dispersant include citric acid, malic acid, trisodium citrate, tripotassium citrate, trilithium citrate, triammonium citrate, disodium malate, tannic acid, Gallo tannic acid, Gallo tannin and the like, one or more of which may be used independently or in combination.

Further, the dispersant formed of a mercapto acid or a salt thereof having two or more COOH and SH groups in a total number is preferably used. The dispersant is adsorbed to surfaces of the silver particles through mercapto groups thereof to form the silver colloid particles.

The dispersant also acts to stabilize the colloid solution by allowing the silver colloid particles to be uniformly dispersed in the water-based dispersion medium (colloid solution) under electrical repulsion forces of the COOH groups present in the dispersant.

If the total number of the COOH and SH groups contained in the dispersant is less than two, that is, one of the COOH and SH groups is contained in the dispersant, there is a case that dispersibility of the silver colloid particles cannot be obtained sufficiently.

Examples of the dispersant include mercaptoacetic acid, mercaptopropionic acid, thiodipropionic acid, mercaptosuccinic acid, thioacetic acid, sodium mercaptoacetate, sodium mercaptopropionate, sodium thiodipropionate, disodium mercaptosuccinate, potassium mercaptoacate, potassium mercaptopropionate, potassium thiodipropionate, dipotassium mercaptosuccinate, and the like, one or more of which may be used independently or in combination.

An amount of the silver colloid particles contained in the ink (colloid solution) is in the range of about 1 to 60 wt %, and more preferably in the range of about 10 to 50 wt %. If the amount of the silver colloid particles falls below the lower limit value noted above, an absolute amount of the silver contained in the ink becomes too small. As a result, there is a need to apply the ink several times when the conductive pattern is formed into a relatively thick film.

In contrast, if the amount of the silver colloid particles exceeds the upper limit value noted above, the amount of the silver colloid particles contained in the ink becomes too great unnecessarily, thus reducing dispersibility of the silver colloid particles. In order to avoid the dispersibility reduction, it is necessary to increase frequency of stirring the ink.

An average particle size of the silver colloid particles is preferably in the range of 1 to 100 nm, and more preferably in the range of 10 to 30 nm. This makes it possible to obtain an ink which can be ejected more stably, and to form a conductive pattern having a fine pattern with ease.

When the silver colloid particles is heated up to 500° C. in a thermogravimetric analysis, a heat loss of the silver colloid particles is preferably in the range of about 1 to 25 wt %. As the silver colloid particles (solid contents) is heated up to 500° C., the dispersant and the residual reducing agent described below are oxidatively decomposed and are gasified and eliminated for their most parts.

Since a quantity of the residual reducing agent seems to be insignificant, it may be conceived that the loss of the silver colloid particles when heated up to 500° C. corresponds substantially to a quantity of the dispersant present in the silver colloid particles.

If the loss-on-heating is smaller than 1 wt %, the quantity of the dispersant relative to that of the silver particles becomes too small, thus reducing dispersibility of the silver particles (silver colloid particles). In contrast, if the loss-on-heating is greater than 25 wt %, the quantity of the residual dispersant relative to that of the silver particles becomes too great, consequently increasing specific resistance of the conductive pattern.

The specific resistance can be improved to a certain degree by heating and sintering the conductive pattern after formation thereof to decompose and eliminate organic components. Therefore, it is preferred that the ink of the present invention is used for forming the conductive pattern on a substrate which is sintered at a higher temperature, such as a ceramic substrate.

Further, an amount of the silver particles (which do not adsorb the dispersant) contained in the ink is in the range of 0.5 to 60 wt %, and more preferably in the range of 10 to 45 wt %. This makes it possible to more effectively prevent the occurrence of the disconnection of the conductive pattern. Therefore, it is possible to provide a conductive pattern having higher reliability.

In this regard, it is to be noted that a method of producing the silver colloid particles will be described below in detail.

Disconnection Preventive Agent

The conductive pattern formation ink contains a disconnection preventive agent composed of an organic matter. This disconnection preventive agent has a function of providing such a property that the pre-pattern can be deformed according to thermal expansion of the ceramic molded body due to the degreasing and sintering treatment to thereby prevent occurrence of disconnection of the conductive pattern.

Meanwhile, in the case where a conventional conductive pattern formation ink is used, there is a problem in that when a ceramic molded body is subjected to a degreasing and sintering treatment, disconnection occurs in a part of the formed conductive pattern due to thermal expansion of the ceramic molded body. Recently, densification of a circuit substrate (wiring substrate) is progressed by further miniaturizing a wiring and reducing pitches of the wirings, and therefore such a problem becomes serious.

In contrast, the conductive pattern formation ink of the present invention contains the disconnection preventive agent composed of the organic matter and having a function of providing such a property that the pre-pattern can be deformed according to the thermal expansion of the ceramic molded body due to the degreasing and sintering treatment.

Use of such an organic matter ensures that molecules constituting it exist between the silver colloid particles. This makes it possible to maintain an adequate distance between the silver colloid particles and to prevent them from aggregating together. As a result, until the organic matter is decomposed, any grain growth of the silver particles is suppressed due to fusion thereof, namely, it is suppressed that the silver particles become a bulk state.

A conductive pattern formed from the silver particles in the bulk state due to the progress of the grain growth thereof, and the binder contained in the ceramic molded body have a large difference in their thermal expansion coefficients. As a result, when the conductive pattern and the ceramic molded body are thermally expanded, stress is generated therebetween. Disconnection of the conductive pattern occurs due to the generated stress.

Whereas, until the organic matter is decomposed, by preventing aggregation of the silver particles due to existence thereof, the organic matter predominantly acts on a thermal expansion coefficient of the pre-pattern containing it. Therefore, the pre-pattern can be reliably deformed according to the thermal expansion of the ceramic molded body.

For these reasons, occurrence of disconnection of the formed conductive pattern can be prevented. As a result, the conductive pattern can exhibit high reliability. Especially, in the case where fine conductive patterns are formed at tight pitches by ejecting the conductive pattern formation ink of the present invention from the ink jet head (liquid droplet ejection head), the above mentioned effects can be obtained remarkably.

In the case where a thermal decomposition starting temperature of the organic matter is defined as T₁ [° C.] and a thermal decomposition starting temperature of the binder containing in the ceramic molded body is defined as T₂ [° C.], the T₁ and T₂ preferably satisfy a relation of −150≦T₁−T₂≦50, and more preferably satisfy a relation of −100≦T₁−T₂≦0.

By satisfying such a relation, the pre-pattern can be more reliably deformed according to the thermal expansion of the ceramic molded body. This makes it possible to prevent the occurrence of the disconnection of the conductive pattern.

Further, when the ceramic molded body is sintered, the organic matter as the disconnection preventive agent is more reliably decomposed and removed from the pre-pattern (conductive pattern). As a result, it is possible to further improve an electrical property of the conductive pattern.

In this regard, it is to be noted that, in the specification, the term “thermal decomposition starting temperature” means a temperature at which a mass change measured according to “JIS K 7120 Testing Methods of Plastics by Thermogravimetry” is started.

Specifically, the thermal decomposition starting temperature of the organic matter is preferably in the range of 200 to 400° C., and more preferably in the range of 250 to 350° C. This makes it possible to more reliably prevent the occurrence of the disconnection of the conductive pattern due to the thermal expansion of the ceramic molded body.

Further, when the ceramic molded body is sintered, the organic matter as the disconnection preventive agent is more reliably decomposed and removed from the pre-pattern (conductive pattern). As a result, it is possible to further improve an electrical property of the conductive pattern.

Examples of the above organic matter include a polyglycerin compound having a polyglycerin chemical structure such as polyglycerin or polyglycerin ester, polyethylene glycol, and the like, one or more of which may be used independently or in combination.

Examples of the polyglycerin ester include polyglycerin monostearate, polyglycerin tristearate, polyglycerin tetrastearate, polyglycerin monooleate, polyglycerin pentaoleate, polyglycerin monolaurate, polyglycerin monocaprylate, polyglycerin polycyanurate, polyglycerin sesquistearate, polyglycerin decaoleate, polyglycerin sesquioleate, and the like.

The above organic matter is constituted from molecules each having a relatively high molecular weight, that is, molecules each having a relatively long chain length. By allowing the molecules to exist between adjacent silver colloid particles and cling to them, the adjacent silver colloid particles can be firmly joined together through the molecules.

As a result, the pre-pattern can be more reliably deformed according to thermal expansion of the ceramic molded body, that is, deformation of the ceramic molded body due to the thermal expansion thereof. Therefore, it is possible to more effectively prevent the occurrence of the disconnection of the formed conductive pattern. This makes it possible to provide a conductive pattern having higher reliability.

Among the compounds stated above, it is preferable to use the polyglycerin compound with the polyglycerin chemical structure, and more preferable to use the polyglycerin. This makes it possible to further effectively prevent the occurrence of the disconnection of the conductive pattern due to the thermal expansion of the ceramic molded body. The polyglycerin compound is also preferred because it exhibits increased solubility to the water-based dispersion medium.

A weight average molecular weight of the polyglycerin compound used herein is preferably in the range of 300 to 3000, and more preferably in the range of 400 to 600. By using such a polyglycerin compound having the above weight average molecular weight, the pre-pattern can be more reliably deformed according to the thermal expansion of the ceramic molded body. This makes it possible to prevent the occurrence of the disconnection of the conductive pattern.

If the weight average molecular weight of the polyglycerin compound falls below the lower limit value noted above, the polyglycerin compound is apt to be decomposed prior to decomposition of the binder contained in the ceramic molded body. As a result, there is a case that the effect of preventing the occurrence of the disconnection of the conductive pattern cannot be obtained sufficiently.

If the weight average molecular weight of the polyglycerin compound exceeds the upper limit value noted above, dispersibility of the silver colloid particles in the water-based dispersion medium (colloid solution) is reduced by an excluded volume effect of the polyglycerin compound or the like.

Examples of the polyethylene glycol include polyethylene glycol #200 (having a weight average molecular weight of 200), polyethylene glycol #300 (having a weight average molecular weight of 300), polyethylene glycol #400 (having a weight average molecular weight of 400), polyethylene glycol #600 (having a weight average molecular weight of 600), polyethylene glycol #1000 (having a weight average molecular weight of 1000), polyethylene glycol #1500 (having a weight average molecular weight of 1500), polyethylene glycol #1540 (having a weight average molecular weight of 1540), polyethylene glycol #2000 (having a weight average molecular weight of 2000), and the like.

An amount of the organic matter as the disconnection preventive agent (particularly, the polyglycerin compound) contained in the ink (colloid solution) is preferably in the range of 7 to 30 wt %, more preferably in the range of 7 to 25 wt %, and even more preferably in the range of 7 to 22 wt %. This makes it possible to more effectively prevent the occurrence of the disconnection of the conductive pattern due to the thermal expansion of the ceramic molded body.

If the amount of the organic matter is smaller than the lower limit value noted above, the effect of preventing the occurrence of the disconnection of the conductive pattern is reduced in the case where the weight average molecular weight thereof falls below the lower limit value noted above.

On the other hand, if the amount of the organic matter is greater than the upper limit value noted above, dispersibility of the silver colloid particles in the water-based dispersion medium (colloid solution) is reduced in the case where the weight average molecular weight thereof exceeds the upper limit value noted above.

Other Ingredients

The conductive pattern formation ink may contain a drying suppressant for suppressing drying of the colloid solution (conductive pattern formation ink). In the case where the ink contains such a drying suppressant, the following effects can be obtained.

Specifically, for example, in the case where the conductive pattern is formed by ejecting the ink using an ink jet method (liquid droplet ejecting method), it is possible to suppress the water-based dispersion medium from evaporating in the vicinity of liquid droplet ejection portions of a liquid droplet ejection head, even when the ejecting operation of the ink is stopped or the ink is ejected continuously for a long period of time.

This makes it possible to stably eject the conductive pattern formation ink from the liquid droplet ejection portions of the liquid droplet ejection head. As a result, it is possible to form a pre-pattern having a relatively uniform width. Therefore, when the ceramic molded body is subjected to the degreasing and sintering treatment, the occurrence of the disconnection of the conductive pattern can be prevented more reliably. Further, a conductive pattern having a desired shape can be formed with high accuracy.

As such a drying suppressant, a polyalcohol having two or more hydroxyl groups in a molecule thereof can be used. Use of the polyalcohol makes it possible to more effectively suppress evaporation of the water-based dispersion medium (drying of the dispersion solution) due to interaction (e.g., formation of hydrogen bonds, van der Waals bonds or the like) between the polyalcohol and the water-based dispersion medium. As a result, it is possible to more effectively suppress the evaporation of the water-based dispersion medium in the vicinity of the liquid droplet ejection portions of the liquid droplet ejection head.

Further, it is possible to easily remove the polyalcohol from the conductive pattern, for example, by decomposition thereof when forming the conductive pattern. Furthermore, use of the polyalcohol makes it possible to appropriately adjust a viscosity of the conductive pattern formation ink, thereby further improving film-forming capability thereof. As a result, when the ceramic molded body is subjected to the degreasing and sintering treatment, the occurrence of the disconnection of the conductive pattern can be prevented more effectively.

Examples of the polyalcohol include ethylene glycol, 1,3-butylene glycol, 1,3-propanediol, propylene glycol, various kinds of sugar alcohols obtained by reducing aldehyde groups and/or ketone groups included in chemical structures of sugars to the hydroxyl groups, and the like, one or more of which may be used independently or in combination.

Among them, it is preferred that the polyalcohol containing at least one kind of the sugar alcohols is used. This makes it possible to more reliably suppress evaporation of the water-based dispersion medium in the vicinity of the liquid droplet ejection portions of the liquid droplet ejection head.

Further, this makes it possible to more easily remove the at least one kind of the sugar alcohols from the conductive pattern by oxidatively decomposing it when forming the conductive pattern through the sintering treatment.

Further, when a patterned film formed using the conductive pattern formation ink, that is, a pre-pattern before being transformed (changed) into the conductive pattern is dried (namely, the water-based dispersion medium is removed from the pre-pattern), the at least one of the sugar alcohols is precipitated in the pre-pattern due to the evaporation of the water-based dispersion medium therefrom.

This makes it possible to increase a viscosity of the conductive pattern formation ink constituting the pre-pattern. Therefore, it is possible to more reliably prevent the conductive pattern formation ink from diffusing toward an undesired region on the ceramic molded body.

As a result, a conductive pattern having a desired shape can be formed on the ceramic sintered body with high accuracy. Further, when the ceramic molded body is subjected to the degreasing and sintering treatment, the occurrence of the disconnection of the conductive pattern can be prevented more reliably.

Further, it is preferred that the polyalcohol containing two or more kinds of the sugar alcohols is used. This makes it possible to more reliably suppress evaporation of the water-based dispersion medium in the vicinity of the liquid droplet ejection portions of the liquid droplet ejection head.

Further, examples of the sugar alcohol include threitol, erythritol, pentaerythritol, dipentaerythritol, tripentaerythritol, arabitol, ribitol, xylitol, sorbitol, mannitol, gulitol, talitol, galactitol, allitol, altritol, dolucitol, iditol, glycerin (glycerol), inositol, maltitol, isomaltitol, lactitol, turanitol and the like, one or more of which may be used independently or in combination.

Among them, the polyalcohol preferably contains at least one kind of the sugar alcohols selected from the group comprising glycerin, xylitol, sorbitol, erythritol, maltitol, mannitol, galactitol, inositol and lactitol, and more preferably contains two or more kinds of the sugar alcohols selected from the above group. This makes it possible to enhance the above effect obtained by using the sugar alcohol as the drying suppressant.

In the case where the at least one of the sugar alcohols is contained in the drying suppressant, an amount thereof is preferably equal to or more than 15 wt %, more preferably equal to or more than 30 wt %, and even more preferably in the range of 40 to 70 wt %. This makes it possible to more reliably suppress evaporation of the water-based dispersion medium in the vicinity of the liquid droplet ejection portions of the liquid droplet ejection head.

Further, it is preferred that the polyalcohol containing 1,3-propanediol is used. This makes it possible to more effectively suppress evaporation of the water-based dispersion medium in the vicinity of the liquid droplet ejection portions of the liquid droplet ejection head, and to appropriately adjust a viscosity of the conductive pattern formation ink. Therefore, it becomes possible to more stably eject the conductive pattern formation ink from the liquid droplet ejection portions of the liquid droplet ejection head.

In the case where the 1,3-propanediol is contained in the drying suppressant, an amount thereof is preferably in the range of 10 to 70 wt %, and more preferably in the range of 20 to 60 wt %. This makes it possible to more stably eject the conductive pattern formation ink from the liquid droplet ejection portions of the liquid droplet ejection head.

An amount of the drying suppressant contained in the ink (colloid solution) is preferably in the range of 3 to 25 wt %, and more preferably in the range of 5 to 20 wt %. This makes it possible to more effectively suppress evaporation of the water-based dispersion medium in the vicinity of the liquid droplet ejection portions of the liquid droplet ejection head, thereby enabling to form a conductive pattern having a desired shape with high accuracy.

In contrast, if the amount of the drying suppressant contained in the ink is lower than the lower limit value noted above, there is a case that a suppression effect for suppressing drying of the ink (colloid solution) cannot be obtained sufficiently.

On the other hand, if the amount of the drying suppressant contained in the ink exceeds the upper limit value noted above, the amount of the drying suppressant becomes excessively large as compared with that of the silver particles (silver colloid particles). Therefore, in the case where the pre-pattern is sintered to obtain a conductive pattern, the drying suppressant is apt to remain in the conductive pattern.

This causes increase of specific resistance of the conductive pattern. In this regard, the specific resistance of the conductive pattern can be improved to a certain degree, by controlling sintering conditions such as a sintering time and a sintering atmosphere.

Further, the conductive pattern formation ink may contain an acetyleneglycol-based compound, in addition the above ingredients.

The acetyleneglycol-based compound has a function of adjusting a contact angle of the conductive pattern formation ink with respect to the ceramic molded body to a predetermined range. In other words, the acetyleneglycol-based compound is preferred because it can adjust the contact angle of the ink with respect to the ceramic molded body to the predetermined range with a small additive amount.

Furthermore, in the case where the ink contains such an acetyleneglycol-based compound, even if air bubbles are generated (contaminated) into the pre-pattern of the conductive pattern, they can be rapidly removed from the pre-pattern. As described above, by adjusting the contact angle of the ink with respect to the ceramic molded body to the predetermined range, it is possible to form a finer conductive pattern.

Especially, even in the case where such a finer conductive pattern is formed, since the ink contains the above disconnection preventive agent, it is possible to reliably prevent the occurrence of the disconnection of the conductive pattern.

Specifically, by using the acetyleneglycol-based compound, the contact angle of the ink with respect to the base member is adjusted preferably to the range of 45 to 85°, and more preferably to the range of 50 to 80°. If the contact angle is very small, there is a fear that a conductive pattern having a fine line width cannot be formed.

On the other hand, if the contact angle is very large, there is a fear that a conductive pattern having an even line width cannot be formed. Further, in the case where the ink is ejected in the form of liquid droplets using a liquid droplet ejecting method, when the liquid droplet is landed on the ceramic molded body, a contact area therebetween becomes very small. As a result, there is a case that the landed liquid droplet slips from its landed point.

Examples of the acetyleneglycol-based compound include SURFYNOL 104 series (e.g., 104E, 104H, 104PG-50, 104PA), SURFYNOL 400 series (e.g., 420, 465, 485), OLFINE series (e.g., EXP4036, EXP4001, E1010) and the like, one or more of which may be used independently or in combination. Here, “SURFYNOL” and “OLFINE” are product names of Nissin Chemical Industry Co., Ltd.

It is preferred that the conductive pattern formation ink contains two or more kinds of the acetyleneglycol-based compounds having different HLB values. This makes it possible to easily adjust the contact angle of the conductive pattern formation ink with respect to the ceramic molded body to the predetermined range.

Especially, in the two or more kinds of the acetyleneglycol-based compounds, a HLB value difference between the acetyleneglycol-based compound having the highest HLB value and the acetyleneglycol-based compound having the lowest HLB value is preferably in the range of 4 to 12, and more preferably in the range of 5 to 10. This makes possible to adjust the contact angle of the conductive pattern formation ink with respect to the ceramic molded body to the predetermined range with a smaller additive amounts of the acetyleneglycol-based compounds (that is, a surface tension adjuster).

In the case where the ink containing the two or more kinds of the acetyleneglycol-based compounds is used, a HLB value of the acetyleneglycol-based compound having the highest HLB value is preferably in the range of 8 to 16, and more preferably in the range of 9 to 14. On the other hand, in this case, a HLB value of the acetyleneglycol-based compound having the lowest HLB value is preferably in the range of 2 to 7, and more preferably in the range of 3 to 5.

An amount of the acetyleneglycol-based compound cantained in the ink (colloid solution) is preferably in the range of 0.001 to 1 wt %, and more preferably in the range of 0.01 to 0.5 wt %. This makes it possible to more effectively adjust the contact angle of the conductive pattern formation ink with respect to the ceramic molded body to the predetermined range.

Constituent ingredients of the conductive pattern formation ink are not limited to the above ingredients, and may contain other ingredients than the above ingredients.

Although the silver colloid particles including the silver particles are dispersed in the ink (colloid solution) according to the description made above, the colloid particles may include other metal particles than the silver particles. Examples of a metal constituting the other metal particles include copper, palladium, platinum, gold, alloy thereof, and the like, and one or more of which may be used independently or in combination.

In the case of using metal particles composed of the alloy, the alloy may contain the above mentioned metal as its major component, and other metals. Further, it may also be possible to use alloy obtained by mixing the above mentioned metals with each other in an arbitrary ratio. Mixed particles (e.g., combination of silver particles, copper particles and palladium particles mixed in an arbitrary ratio) may be dispersed in the ink (colloid solution).

The above mentioned metals are low in resistivity and are stable such that they are not oxidized by a heat treatment. Therefore, use of these metals makes it possible to form a conductive pattern that exhibits low resistance and high stability.

Method of Producing Conductive Pattern Formation Ink

Next, one example of a method of producing the above conductive pattern formation ink will be described.

As described above, the ink is comprised of the colloid solution containing the silver colloid particles in which the dispersant is adsorbed on surfaces of the silver particles. In this embodiment, the colloid solution is obtained by preparing an aqueous solution in which a dispersant and a reducing agent are dissolved, and then dropping an aqueous silver salt solution into the aqueous solution.

When the aqueous silver salt solution is dropped into the aqueous solution, Ag⁺ ions derived from a silver salt contained in the aqueous silver salt solution are reduced by the reducing agent contained in the aqueous solution, so that the Ag⁺ ions are transformed into silver atoms to produce the silver particles in the aqueous solution. Therefore, in this embodiment, the silver salt is a starting material for producing the silver particles.

In the method of producing the ink of this embodiment, the aqueous solution is, first, prepared in which the above dispersant and reducing agent are dissolved.

The dispersant is blended preferably in such a blending quantity that a mole ratio of the dispersant to silver contained in the silver salt becomes equal to about 1:1 to 1:100. Examples of the silver salt, which is the starting material of the silver particles, include silver nitrate and the like.

If the mole ratio of the dispersant to the silver salt becomes greater, a particle size of the silver particles grows smaller and contact points between the silver particles are increased. This makes it possible to obtain a conductive pattern whose volume resistance value is low.

As described above, the reducing agent acts to generate the silver particles through a reduction of Ag⁺ ions contained in the silver salt (starting material) such as the silver nitrate (Ag⁺NO³⁻) or the like.

The reducing agent is not particularly limited to a specific type. Examples of the reducing agent include: an amine-based reducing agent such as hydrazine, dimethylaminoethanol, methyldiethanolamine or triethanolamine; a hydrogen compound-based reducing agent such as sodium boron hydroxide, a hydrogen gas or hydrogen iodide; an oxide-based reducing agent such as carbon monoxide, sulfurous acid or hypophosphorous acid; a low-valent metal salt-based reducing agent such as a Fe (II) compound or a Sn (II) compound; an organic compound-based reducing agent such as sugar (e.g., D-glucose) or formaldehyde; a hydroxy acid, cited above as the dispersant, such as citric acid, malic acid or tannic acid; a hydroxy acid salt, cited above as the dispersant, such as trisodium citrate, tripotassium citrate, trilithium citrate, triammonium citrate or disodium malate; and the like. Among them, the hydroxy acid (including the tannic acid) or the salt thereof serve as both the reducing agent and the dispersant.

Further, the mercapto acid or the salt thereof, cited above as the dispersant, is preferably used as the reducing agent. This is because the mercapto acid or the salt thereof can be bonded to surfaces of the silver particles (metal particles) stably.

Examples of the mercapto acid include mercaptoacetic acid, mercaptopropionic acid, thiodipropionic acid, mercaptosuccinic acid and thioacetic acid. On the other hand, examples of the mercapto acid salt include sodium mercaptoacetate, sodium mercaptopropionate, sodium thiodipropionate, disodium mercaptosuccinate, potassium mercaptoacate, potassium mercaptopropionate, potassium thiodipropionate and dipotassium mercaptosuccinate.

These reducing agents and dispersants may be used independently or in combination. When using these compounds, it may be possible to accelerate a reducing reaction by applying light or heat thereto.

The reducing agent is blended in such a blending quantity as to completely reduce the silver salt which is the starting material of the silver particles. If the blending quantity is excessive, the reducing agent remains in the colloid solution (aqueous silver colloid solution) as impurities, which may be a cause of adversely affecting conductivity of the formed conductive pattern.

This means that the blending quantity should preferably be a smallest possible quantity. More specifically, the blending quantity is such that a mole ration of the silver salt to the reducing agent becomes equal to about 1:1 to 1:3.

In this embodiment, it is preferred that, after the aqueous solution is prepared by dissolving the dispersant and the reducing agent in the solvent, pH of the aqueous solution is adjusted to 6 to 10.

The reason is as follows. For example, in the case of mixing the trisodium citrate as the dispersant and ferrous sulfate as the reducing agent, the pH of the aqueous solution becomes equal to about 4 to 5 depending on an overall concentration thereof, which falls below the pH 6 mentioned above.

At this time, equilibrium of a reaction represented by the following reaction equation (1) is shifted to the right side by hydrogen ions existing in the aqueous solution, thereby increasing a quantity of the COOH groups.

—COO⁻+H⁺→—COOH (1)

This reduces electrical repulsion forces of the surfaces of the silver particles obtained by subsequently dropping the aqueous silver salt solution, which leads to reduction in dispersibility of the silver particles (silver colloid particles).

For this reason, after the aqueous solution has been prepared by dissolving the dispersant and the reducing agent in the solvent, an alkaline compound is added to the aqueous solution to reduce a hydrogen ion concentration thereof.

The alkaline compound added at this time is not particularly limited to a specific type. Examples of the alkaline compound include sodium hydroxide, potassium hydroxide, lithium hydroxide, ammonia water and the like. Among them, it is preferable to use the sodium hydroxide that can easily adjust the pH with a small amount.

In this regard, addition of the alkaline compound in a quantity great enough to increase the pH of the aqueous solution to more than 10 is undesirable, because the hydroxide of ions of a residual reducing agent (that is, residue of the reducing agent) such as iron ions or the like is apt to precipitate.

Next, in the method of producing the ink of this embodiment, the aqueous silver salt solution containing the silver salt is dropped into the aqueous solution in which the dispersant and the reducing agent are dissolved.

The silver salt is not particularly limited to a specific type. Examples of the silver salt include silver acetate, silver carbonate, silver oxide, silver sulfate, silver nitrite, silver chlorate, silver sulfide, silver chromate, silver nitrate, silver dichromate and the like. Among them, it is preferable to use the silver nitrate that exhibits high water-solubility.

A quantity of the silver salt is decided by taking into account a target amount of the silver colloid particles and a percentage of the silver salt reduced by the reducing agent. In the case of the silver nitrate, about 15 to 70 mass parts of the silver nitrate is used on the basis of 100 mass parts of the aqueous silver salt solution.

The aqueous silver salt solution is prepared by dissolving the silver salt in pure water and is gradually dropped into the aqueous solution in which the dispersant and the reducing agent are dissolved.

As described above, in this step, the Ag⁺ ions contained in the silver salt is reduced by the reducing agent so that the Ag⁺ ions are transformed into silver atoms to produce the silver particles in the aqueous solution. At this time, the dispersant is adsorbed to the surfaces of the silver particles to form silver colloid particles.

This produces an aqueous solution (aqueous dispersion solution) in which the silver colloid particles are dispersed in a colloidal form, that is, the colloid solution.

In addition to the silver colloid particles, the residual reducing agent and the dispersant are likely to exist in the thus obtained colloid solution as ions. Thus, an ion concentration of the colloid solution as a whole becomes high.

In the colloid solution of this state, the silver particles are aggregated to produce aggregates and the aggregates are easily precipitated. For this reason, it is preferred that cleaning is performed to remove superfluous ions of the residual reducing agent and dispersant present in the colloid solution and to reduce the ion concentration thereof.

Cleaning methods include: a method of repeating several times the steps of leaving the colloid solution containing the silver colloid particles at rest for a specified time, removing supernatant liquid thus created, adding pure water to the colloid solution, stirring the colloid solution, leaving the colloid solution at rest for a specified time and removing supernatant liquid thus created; a method of performing centrifugal separation in place of leaving the colloid solution at rest; a method of removing ions by ultrafiltration; and the like.

Further, the following method may be used. In this method, first, after the colloid solution is produced, the pH thereof is adjusted to an acidic area of 5 or lower so that the above reaction equation (1) is shifted to the right side, thereby positively aggregating the silver colloid particles (metal colloid particles) due to reduction of the electrical repulsion forces of the surfaces of the silver particles. Next, in this aggregated state of the silver colloid particles, salts and the solvent are removed from the colloid solution.

In this regard, in the case where a sulfur compound having a low molecular weight such as the mercapto acid is used as the dispersant, such a sulfur compound forms stable bonds to the surfaces of the silver particles (metal particles) to produce the silver colloid particles (metal colloid particles). Therefore, by adjusting the pH of the colloid solution to an alkaline area of 6 or higher once again, the aggregated silver colloid particles are re-dispersed therein with ease. In this way, it is possible to obtain a colloid solution having excellent dispersion stability.

In the method of producing the ink of this embodiment, it is preferred that, at the end of the above step, the pH of the colloid solution, in which the silver colloid particles are dispersed, is finally adjusted to 6 through 11 by adding, if necessary, an aqueous alkali metal hydroxide solution to the colloid solution.

Due to the cleaning performed after reduction, a concentration of sodium ions as electrolytic ions is sometimes decreased. With the colloid solution of this state, equilibrium of a reaction represented by the following reaction equation (2) is shifted to the right side.

—COO⁻Na⁺+H₂O→—COOH+Na⁺+OH⁻ (2)

In this case, the silver colloid particles exhibits a decrease in its electrical repulsion force and they (that is, the silver particles) suffer from reduction in its dispersibility. For this reason, the equilibrium of the reaction equation (2) is shifted to the left side and the silver colloid particles are stabilized by adding an appropriate amount of alkali metal hydroxide.

The alkali metal hydroxide used at this time includes, e.g., the same compound as used in first adjusting the pH of the above aqueous solution. If the pH is lower than 6, the equilibrium of the reaction equation (2) is shifted to the right side, consequently making the silver colloid particles unstable.

In contrast, if the pH is higher than 11, precipitation of hydroxide salt of residual ions such as iron ions is apt to occur, which is undesirable. In the case where the iron ions or the like are removed in advance, no big problem is posed even when the pH is higher than 11.

It is preferred that positive ions such as sodium ions are added in the form of hydroxide. This makes it possible to use self-protolysis of water. Therefore, this is the most effective way of adding the positive ions such as sodium ions to the colloid solution.

Next, the above other ingredients including the disconnection preventive agent and the like are added to the colloid solution produced in this way, to thereby obtain a conductive pattern formation ink (the conductive pattern formation ink of the present invention).

In this regard, an addition timing of the other ingredients including the disconnection preventive agent and the like to the colloid solution is not limited to a specific point of time. Namely, they may be added to the colloid solution at any time after formation of the silver colloid particles.

Conductive Pattern

Next, description will be given on the conductive pattern of this embodiment. The conductive pattern is a thin-film type conductive pattern formed by applying the ink onto the ceramic molded body and heating the same so that the silver particles can be bonded together.

At least on a surface of the conductive pattern, the silver particles are bonded to one another without leaving any gap therebetween. The conductive pattern has specific resistance of less than 20 μΩcm.

Especially, since this conductive pattern is formed using the conductive pattern formation ink of the present invention, it becomes possible to prevent the occurrence of the disconnection of the formed conductive pattern due to the thermal expansion of the ceramic molded body when subjecting the ceramic molded body with the pre-pattern to the degreasing and sintering treatment. Therefore, it is possible to obtain a conductive pattern having a higher reliability.

The conductive pattern of this embodiment is formed by applying the ink onto the ceramic molded body to obtain the pre-pattern, drying the pre-pattern (ink), that is, removing the water-based dispersion medium from the pre-pattern, and then sintering the same.

The drying step is performed preferably at the range of 40 to 100° C., and more preferably at the range of 50 to 70° C. This makes it possible to more effectively prevent generation of cracks when the pre-pattern (ink) has been dried. The sintering step is preferably performed by heating the dried pre-pattern (ink) at 200° C. or more for 20 minutes or more. In this regard, it is to be noted that the sintering step is carried out simultaneously with sintering the ceramic molded body.

A method of applying the ink onto the ceramic molded body is not limited to a specific method, examples of the method include a liquid droplet ejecting method, a screen printing method, a bar coating method, a spin coating method, a brush-used method and the like.

In the case of using the liquid droplet ejecting method (particularly, an ink jet method) among the above-noted methods, it is possible to form a fine and complex conductive pattern in a simple and easy manner.

The specific resistance of the conductive pattern is preferably smaller than 20 μΩcm, and more preferably 15 μΩcm or less. The term “specific resistance” used herein refers to specific resistance available when the ink is applied, heated at 200° C. or more and dried.

If the specific resistance is equal to or greater than 20 μΩcm, it is difficult to use the conductive pattern in a conductivity-requiring application, e.g., in an electrode formed on a circuit substrate.

When forming the conductive pattern of this embodiment, it is possible to provide a thick conductive pattern by repeatedly performing the steps of applying the ink by the afore-mentioned applying method, preliminarily heating the ink to evaporate the water-based dispersion medium, and applying once again the ink on the preliminarily heated film.

The disconnection preventive agent and the silver colloid particles are left (remain) in the ink from which the water-based dispersion medium has been evaporated. Since the disconnection preventive agent has a relatively high viscosity, there is no possibility that the film (pre-pattern) thus formed by the ink may be washed away (diffused) even when it is not fully dried. Therefore, it becomes possible to apply the ink once again after the ink is first applied, dried and left at rest for a long period of time.

Furthermore, since the above disconnection preventive agent has a relatively high boiling point, there is also no possibility that the ink constituting the film (pre-pattern) may undergo a change in quality even when the ink is applied, dried and left at rest for a long period of time. It also becomes possible to apply the ink once again, which makes it possible to form the film (pre-pattern) with a uniform quality.

This eliminates possibility that the conductive pattern may become a multi-layer structure, which would lead to an increase in inter-layer specific resistance and, eventually, an increase in specific resistance of the conductive pattern as a whole.

By going through the above-noted steps, the conductive pattern of this embodiment can be formed thicker than a conductive pattern produced by a conventional ink. More specifically, it is possible to form a conductive pattern whose thickness is equal to or greater than 5 μm.

Since the conductive pattern of this embodiment is formed by the afore-mentioned ink, cracks are seldom generated even when the conductive pattern is formed into a thickness of 5 μm or more. This makes it possible to construct a conductive pattern with reduced specific resistance.

There is no need to particularly restrict an upper limit of the thickness of the conductive pattern. However, if the thickness of the conductive pattern is too great, difficulties may be encountered in removing the water-based dispersion medium and the disconnection preventive agent, which may possibly increase the specific resistance of the conductive pattern. For this reason, it is preferred that the conductive pattern has a thickness of about 100 μm or less.

The conductive pattern of this embodiment exhibits good adhesion with respect to the above mentioned ceramic molded body subjected to the degreasing and sintering treatment, that is, the ceramic sintered body.

In this regard, it is to be noted that the conductive pattern described above can be used in high-frequency modules, interposers, micro-electromechanical systems, acceleration sensors, acoustic surface wave devices, antennas, odd-shaped electrodes (including comb electrodes) of mobile communication equipments such as a cellular phone, a PDA or the like, and electronic components of various kinds of measuring instruments.

Wiring Substrate and Method for Producing Wiring Substrate

Next, description will be made on one example of a wiring substrate (ceramic circuit substrate) having the conductive pattern formed by the conductive pattern formation ink of the present invention and one example of a method of producing the wiring substrate.

The wiring substrate of the present invention constitutes an electronic component used in various kinds of electronic equipments. The wiring substrate is produced by forming a circuit pattern, which consists of various kinds of wirings, electrodes and the like, a laminated ceramic condenser, a laminated inductor, an LC filter and a composite high-frequency component on a substrate.

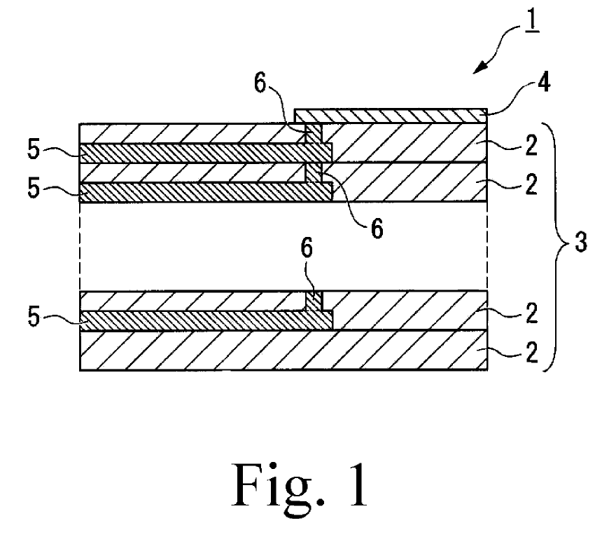

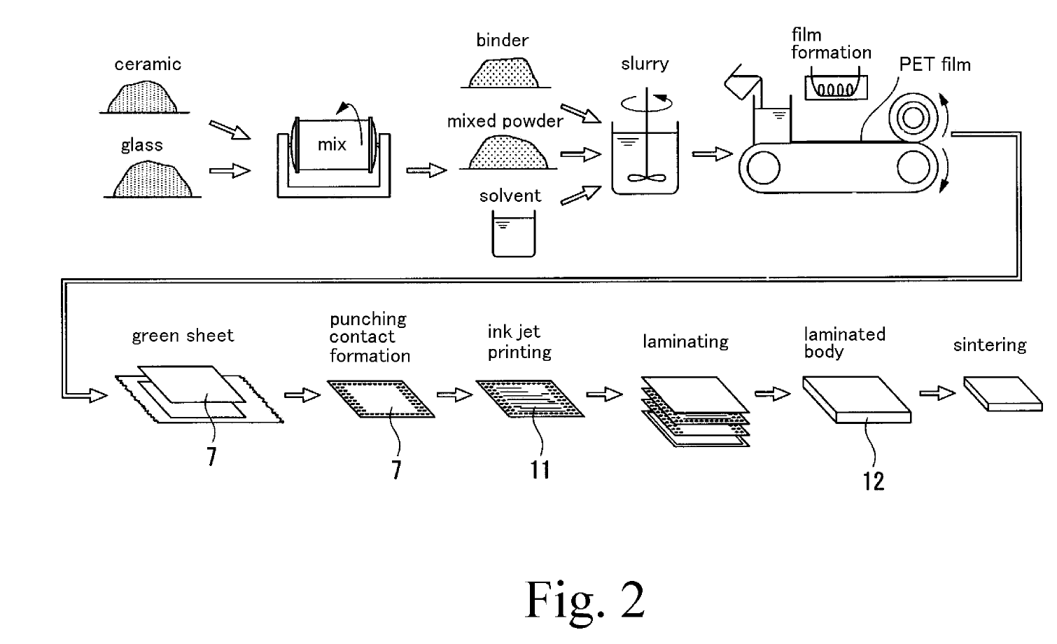

FIG. 1 is a longitudinal section view showing one example of the wiring substrate according to the present invention, that is, a ceramic circuit substrate. FIG. 2 is an explanatory view schematically illustrating the steps of a method of producing the wiring substrate shown in FIG. 1, that is, the ceramic circuit substrate.

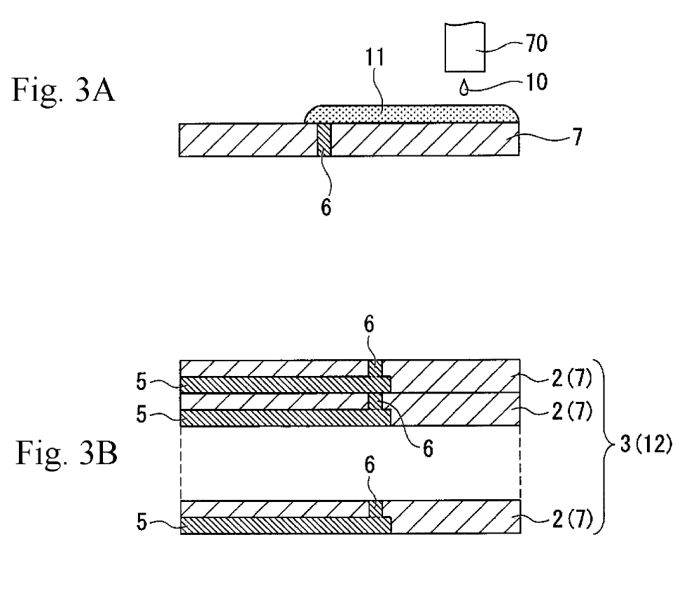

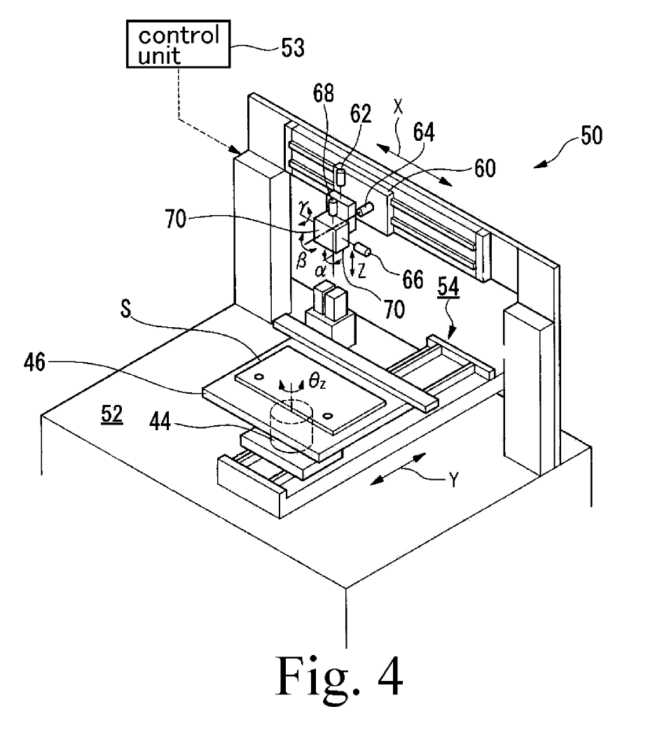

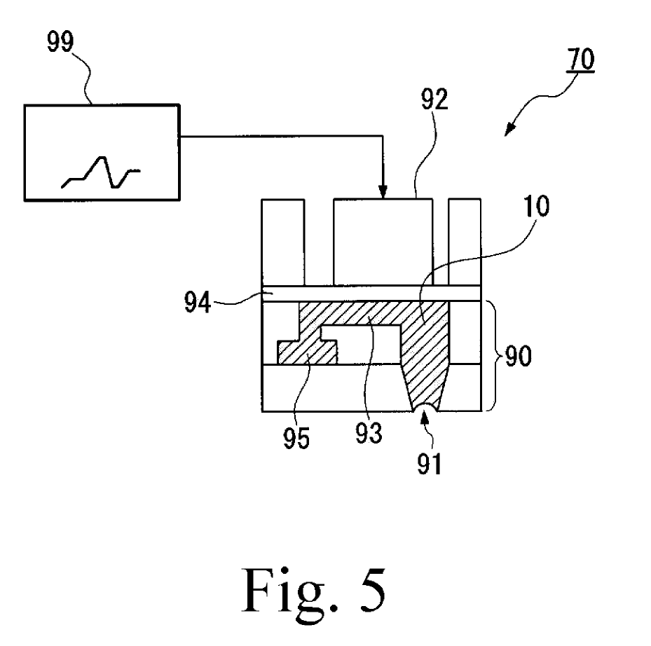

FIGS. 3A and 3B are views for explaining a production process of the wiring substrate shown in FIG. 1, that is, the ceramic circuit substrate. FIG. 4 is a perspective view showing a schematic configuration of an ink jet apparatus. FIG. 5 is a pattern diagram for explaining a schematic configuration of an ink jet head.

As shown in FIG. 1, the ceramic circuit substrate (wiring substrate) 1 includes a laminated substrate 3, which is formed by laminating a plurality of (e.g., about ten through twenty) ceramic substrates 2, and a circuit 4 formed on one outermost layer, i.e., one end surface, of the laminated substrate 3, the circuit 4 being made of fine wirings and the like.

The laminated substrate 3 includes a plurality of circuits (conductive patterns) 5 formed by the conductive pattern formation ink (hereinafter simply referred to as an ink) of the present invention and arranged between the ceramic substrates (ceramic sintered bodies) 2.

Contacts (vias) 6 that make contact with circuits 5 are formed in the circuits 5. With this configuration, the circuits 5 arranged one above another are conducted through the contacts 6. Just like the circuits 5, the circuit 4 is formed by the conductive pattern formation ink of the present invention.

Next, a method of producing the ceramic circuit substrate 1 will be described with reference to the schematic process view illustrated in FIG. 2.

Prepared first as raw powder are ceramic powder composed of alumina (Al₂O₃) and titanium oxide (TiO₂) each having an average particle size of about 1 to 2 μm and glass powder composed of boron silicate glass having an average particle size of about 1 to 2 μm.

The ceramic powder and the glass powder are mixed with each other in an appropriate mixing ratio, e.g., in a weight ratio of 1:1 to obtain a mixed powder.

Next, slurry is obtained by adding a suitable binder, a plasticizer, an organic solvent (dispersant) and the like to the mixed powder, and then mixing and stirring the same. In this regard, it is to be noted that polyvinyl butyral is preferably used as the binder. The polyvinyl butyral is water-insoluble and is apt to be dissolved or swollen in what is called an oil-based organic solvent.

Then, the slurry thus obtained is coated on a PET film in a sheet shape using a doctor blade, a reverse coater or the like. Depending on production conditions of an article, the slurry is formed into a sheet having a thickness of several micrometers to several hundred micrometers, and then the sheet is wound into a roll.

Subsequently, the roll is severed in conformity with use of the article and is cut into a sheet having a specified size. In this embodiment, the roll is cut into, e.g., a square sheet whose one side has a length of 200 mm to obtain a sheet-like ceramic molded body (that is, a ceramic green sheet) 7.

As described below, this ceramic green sheet (ceramic molded body) 7 is subjected to a degreasing and sintering treatment so that it is transformed into the ceramic substrates (ceramic sintered body) 2.

A thermal decomposition starting temperature of the binder contained in the slurry (ceramic green sheet 7) is preferably in the range of about 200 to 500° C., and more preferably in the range of about 300 to 400° C. This makes it possible to prevent the occurrence of the disconnection of the circuits (conductive patterns) 4 and 5 due to the thermal expansion of the ceramic green sheet (ceramic molded body) 7 when subjecting it to the degreasing and sintering treatment.

If necessary, through-holes are formed in given positions by punching (processing) the ceramic green sheet 7 with a CO₂ laser, a YAG laser, a mechanical punch or the like. A thick-film conductive paste in which metal particles are dispersed is filled into the through-holes to form portions which will be transformed into the contacts 6.

Further, portions which will be transformed into terminal portions (not shown) are formed in the given positions of the ceramic green sheet 7 by screen printing the thick-film conductive paste. In this way, the ceramic green sheet 7, on which the portions which will be transformed into the contacts 6 and terminal portions are formed, is obtained.

In this regard, it is to be noted that the conductive pattern formation ink of the present invention can be used as the thick-film conductive paste.

Next, a pre-pattern 11 which will be transformed into the circuits 5 (corresponding to the conductive pattern of the present invention) is formed on one surface of the ceramic green sheet 7 in such a state that the pre-pattern 11 continuously extends from the portions which will be transformed into the contacts 6.

In other words, as illustrated in FIG. 3A, the conductive pattern formation ink 10 (hereinafter simply referred to as an ink 10) described above is applied on the ceramic green sheet 7, thereby forming the pre-pattern 11.

In this embodiment, application of the ink 10 onto the ceramic green sheet 7 can be performed using, for example, an ink jet apparatus (liquid droplet ejecting apparatus) 50 shown in FIG. 4, and an ink jet head (liquid ejecting head) 70 shown in FIG. 5.

Hereinafter, the ink jet apparatus 50 and the ink jet head 70 will be described in detail.

FIG. 4 is a perspective view showing the ink jet apparatus 50. Referring to FIG. 4, the left-and-right direction of a base 52 is designated by a X direction, the back-and-forth direction is designated by a Y direction, and the vertical direction is designated by a Z direction.

The ink jet apparatus 50 includes the ink jet head 70 (hereinafter simply referred to as a head 70) and a table 46 for supporting a substrate S (the ceramic green sheet 7 in this embodiment). An operation of the ink jet apparatus 50 is controlled by means of a control unit 53.

The table 46 for supporting the substrate S can be moved and positioned in the Y direction by means of a first moving means 54 and can be swung and positioned in a θz direction by means of a motor 44.

On the other hand, the head 70 can be moved and positioned in the X direction by means of a second moving means (not shown) and can be moved and positioned in the Z direction by means of a linear motor 62. Furthermore, the head 70 can be swung and positioned in α, β and γ directions by means of motors 64, 66 and 68, respectively.

Based on this configuration, the ink jet apparatus 50 is capable of accurately controlling a relative position and posture between an ink ejecting surface 70P of the head 70 and the substrate S placed on the table 46.

A rubber heater (not shown) is arranged on a rear surface of the table 46. An upper whole surface of the ceramic green sheet 7 placed on the table 46 is heated up to a specified temperature by means of the rubber heater.

At least a part of the water-based dispersion medium is evaporated from a surface side of the ink 10 shot against the ceramic green sheet 7. At this time, evaporation of the water-based dispersion medium is accelerated because the ceramic green sheet 7 remains in a heated state.

The ink 10 shot against the ceramic green sheet 7 is thickened first in a peripheral edge of the surface thereof. That is to say, the peripheral edge of the surface of the ink 10 begins to be thickened because an amount (concentration) of solid contents (silver colloid particles) in the peripheral portion becomes higher than in the central portion more rapidly.

The peripheral edge portion of the ink 10 thus thickened stops its spreading action along a plane direction of the ceramic green sheet 7. This makes it easy to control a shot diameter and hence a line width. A heating temperature of the ceramic green sheet 7 is set equal to the drying conditions mentioned earlier.

As shown in FIG. 5, the head 70 is designed to eject the ink 10 from a nozzle (liquid droplet ejection portion) 91 according to an ink jet system (liquid droplet ejecting system).

The liquid droplet ejecting system may be any technique known in the art, including a piezo system in which the ink is ejected using a piezo element made of a piezoelectric body and a bubble system in which the ink is ejected using the bubbles generated when heating the ink.

Among them, the piezo system is advantageous in that it does not heat the ink and therefore does not affect a composition of materials used. For this reason, the head 70 shown in FIG. 5 employs the piezo system.

The head 70 includes a head main body 90 having a reservoir 95 formed therein and a plurality of ink chambers 93 branched from the reservoir 95. The reservoir 95 serves as a flow path through which the ink 10 is supplied to the respective ink chambers 93.

A nozzle plate (not shown) that constitutes an ink ejecting surface is mounted to a lower end surface of the head main body 90. A plurality of nozzles 91 for ejecting the ink 10 are provided in the nozzle plate in a corresponding relationship with the respective ink chambers 93. Ink flow paths are formed to extend from the respective ink chambers 93 toward the corresponding nozzles 91.

On the other hand, a vibration plate 94 is mounted to an upper end surface of the head main body 90. The vibration plate 94 constitutes wall surfaces of the respective ink chambers 93. Piezo elements 92 are provided outside the vibration plate 94 in a corresponding relationship with the respective ink chambers 93.

The piezo elements 92 are formed of a piezoelectric material such as quartz or the like and a pair of electrodes (not shown) for holding the piezoelectric material therebetween. The electrodes are connected to a driving circuit 99.

If an electrical signal is inputted to the piezo elements 92 from the driving circuit 99, the piezo elements 92 undergo dilation deformation or shrinkage deformation. As the piezo elements 92 undergo shrinkage deformation, pressure of the ink chambers 93 is decreased and the ink 10 is admitted into the ink chambers 93 from the reservoir 95.

As the piezo elements 92 undergo dilation deformation, the pressure of the ink chambers 93 is increased and the ink 10 is ejected from the nozzles 91. A deformation amount of the piezo elements 92 can be controlled by changing a voltage applied thereto.

Furthermore, a deformation speed of the piezo elements 92 can be controlled by changing a frequency of the voltage applied thereto. In other words, ejection conditions of the ink 10 can be controlled by adjusting conditions of the voltage applied to the piezo elements 92.

Accordingly, use of the ink jet apparatus 50 having the head 70 stated above makes it possible to accurately eject and deliver the ink 10 to a desired place of the ceramic green sheet 7 in a desired quantity. Therefore, it is possible to accurately and easily form the pre-pattern 11 as shown in FIG. 3A.

Once the pre-pattern 11 is formed in the above manner, the same steps are repeated to form a required number of, e.g., about ten to twenty, ceramic green sheets 7 each having the pre-pattern 11.

Then, the PET film is peeled off from the ceramic green sheets 7 and a laminated body 12 is obtained by laminating the ceramic green sheets 7 as illustrated in FIG. 2. At this time, the ceramic green sheets 7 are arranged so that, if necessary, the pre-patterns 11 of the ceramic green sheets 7 laminated one above another can be connected through the portions which will be transformed into the contacts 6.

The laminated body 12 thus formed is heated by use of, e.g., a belt type furnace. As a result, the ceramic substrate 2 (wiring substrate of the present invention) is obtained by firing the respective ceramic green sheets 7 as shown in FIG. 3B. Namely, each ceramic green sheet (ceramic molded body) 7 is degreased and sintered due to the heat treatment (that is, the degreasing and sintering treatment), to thereby obtain the ceramic substrate (ceramic sintered body) 2.

As the silver colloid particles forming the pre-patterns 11, including the silver particles (metal particles), are sintered, the pre-patterns 11 are transformed into the circuits (conductive patterns) 5 consisting of a wiring pattern or an electrode pattern. Further, at this time, the portions are also transformed into the contacts 6 and the terminal portions, respectively.

In this way, by subjecting the laminated body 12 to the heat treatment as mentioned above, the laminated body 12 is transformed into the laminated substrate 3 shown in FIG. 1.

In this regard, a heating temperature of the laminated body 12 is preferably equal to or more than a softening point of the glass component (glass powder) contained in the ceramic green sheets 7. More specifically, it is preferred that the heating temperature is in the range of 600 to 900° C.

Heating conditions are selected to make sure that the temperature is elevated and dropped at a suitable speed. Furthermore, the laminated body 12 is maintained for a suitable period of time at a maximum heating temperature, i.e., at the temperature of 600 to 900° C.

The glass component (glass powder) of the ceramic substrates 2 thus obtained can be softened by elevating the heating temperature up to a temperature above the softening point of the glass component, i.e., the temperature range noted above.

Therefore, if the laminated body 12 is subsequently cooled down to a normal temperature so that the glass component can be hardened, the respective ceramic substrates 2 that constitute the laminated substrate 3 are firmly bonded to the circuit (conductive pattern) 5.

The ceramic substrates 2 obtained by heating the laminated body 12 up to the temperature range noted above become what is called low temperature co-fired ceramic (LTCC) which means the ceramic fired at a temperature of 900° C. or less.

Here, the ingredients such as the disconnection preventive agent and the like present in the ink 10 delivered on the ceramic green sheet 7 are decomposed and removed therefrom. Further, the silver particles (metal particles) present in the ink 10 are fused and continuously joined to one another. As a result, it is possible for the formed circuits (conductive patterns) 5 to exhibit conductivity.

By the heat treatment noted above, the circuits 5 are formed to make direct contact with and come into connection with the contacts 6 of the ceramic substrates 2. In a hypothetical case that the circuits 5 are merely placed on the ceramic substrates 2, no mechanical connection strength would be secured between the circuits 5 and the ceramic substrates 2. Therefore, the circuits 5 may be possibly destroyed by shocks or the like.

In this embodiment, however, the circuits 5 are firmly fixed to the ceramic substrates 2 by first softening and then hardening the glass component contained in the ceramic green sheet 7. As a result, the formed circuits 5 can have high mechanical strength.

Using such a heat treatment, the circuit 4 can be formed simultaneously with the circuits 5, thereby producing the ceramic circuit substrate 1.

In the method of producing the ceramic circuit substrate 1 mentioned above, particularly when producing the respective ceramic substrates 2 of which the laminated substrate 3 is formed, the above-mentioned ink 10 (that is, the conductive pattern formation ink of the present invention) is delivered to the ceramic green sheet 7.

This ensures that conductive patterns (circuits) 5 each having high reliability are formed with high dimensional accuracy, while preventing the occurrence of the disconnection of the conductive pattern when producing the ceramic circuit substrate 1.

While certain preferred embodiments of the present invention have been described hereinabove, the present invention is not limited thereto. Although a colloid solution is used in the foregoing embodiments as the dispersion solution prepared by dispersing the metal particles in the water-based dispersion medium, the dispersion solution may not be the colloid solution.

### EXAMPLES

Hereinafter, the present invention will be described in more detail by virtue of examples. However, the present invention is not limited to these examples.

[1] Preparation of Conductive Pattern Formation Ink

In each of Examples and a Comparative Example, a conductive pattern formation ink was produced as follows.

### Examples 1 to 18

17 g of trisodium citrate dihydrate and 0.36 g of tannic acid were dissolved in 50 mL of water alkalified by adding 3 mL of an aqueous 10N NaOH solution thereto, to obtain an aqueous solution. 3 mL of a 3.87 mol/L aqueous silver nitrate solution was added to the aqueous solution thus obtained drop by drop.

A silver colloid solution was obtained by stirring the above aqueous solution for two hours. The silver colloid solution thus obtained was dialyzed until conductivity thereof was decreased to 30 μS/cm or less, thereby desalting the silver colloid solution.

At the end of dialysis, coarse silver colloid particles were removed from the silver colloid solution by performing centrifugal separation at 3000 rpm for 10 minutes.

Thereafter, a disconnection preventive agent, a drying suppressant and an acetyleneglycol-based compound each shown in Table 1 were added to the silver colloid solution, and then ion-exchanged water was added to the silver colloid solution to adjust amounts (contents) of the above ingredients contained therein.

In this regard, SURFYNOL 104PG-50 and OLFINE EXP4036 each produced by Nissin Chemical Industry Co., Ltd. were used as the acetyleneglycol-based compound. By doing so, the conductive pattern formation ink was obtained. Mixing amounts of the ingredients constituting the conductive pattern formation inks of the Examples 1 to 18 are shown in Table 1.

### Comparative Example

A conductive pattern formation ink was prepared in the same manner as in the Example 1 except that the addition of the disconnection preventive agent thereto was omitted.

In this regard, it is to be noted that in Table 1, “XY” shows xylitol, “SB” shows sorbitol, “ER” shows erythritol, “MT” shows maltitol and “GR” shows glycerin.

TABLE 1

| | | disconnection preventive agent | | | | | | | |
|---|---|---|---|---|---|---|---|---|---|
| | | polyglycerin | | | polyglycerin monooleate | | | | |
| | | | | thermal | | | thermal | polyethylene glycol | |
| | silver | | weight | decomposition | | weight | decomposition | | weight |
| | colloid | | average | starting | | average | starting | | average |
| | particles | amount | molecular | temperature | amount | molecular | temperature | amount | molecular |
| | [wt %] | [wt %] | weight | [° C.] | [wt %] | weight | [° C.] | [wt %] | weight |
| Ex. 1 | 40 | 10 | about | 280 | — | — | — | — | — |
| | | | 500 | | | | | | |
| Ex. 2 | 40 | 5 | about | 280 | — | — | — | — | — |
| | | | 500 | | | | | | |
| Ex. 3 | 40 | 7 | about | 280 | — | — | — | — | — |
| | | | 500 | | | | | | |
| Ex. 4 | 40 | 15 | about | 280 | — | — | — | — | — |
| | | | 500 | | | | | | |
| Ex. 5 | 40 | 20 | about | 280 | — | — | — | — | — |
| | | | 500 | | | | | | |
| Ex. 6 | 40 | 10 | about | 250 | — | — | — | — | — |
| | | | 300 | | | | | | |
| Ex. 7 | 40 | 10 | about | 290 | — | — | — | — | — |
| | | | 600 | | | | | | |
| Ex. 8 | 40 | 10 | about | 300 | — | — | — | — | — |
| | | | 750 | | | | | | |
| Ex. 9 | 40 | 10 | about | 280 | — | — | — | — | — |
| | | | 500 | | | | | | |
| Ex. 10 | 40 | 10 | about | 280 | — | — | — | — | — |
| | | | 500 | | | | | | |
| Ex. 11 | 40 | 10 | about | 280 | — | — | — | — | — |
| | | | 500 | | | | | | |
| Ex. 12 | 40 | 10 | about | 280 | — | — | — | — | — |
| | | | 500 | | | | | | |
| Ex. 13 | 40 | — | — | — | 10 | about | 220 | — | — |
| | | | | | | 500 | | | |
| Ex. 14 | 40 | — | — | — | 20 | about | 220 | — | — |
| | | | | | | 500 | | | |
| Ex. 15 | 40 | — | — | — | — | — | — | 10 | about 600 |
| Ex. 16 | 40 | — | — | — | — | — | — | 20 | about 600 |
| Ex. 17 | 40 | 2.5 | about | 280 | 2.5 | about | 220 | — | — |
| | | | 500 | | | 500 | | | |
| Ex. 18 | 40 | 2.5 | about | 280 | — | — | — | 2.5 | about 600 |
| | | | 500 | | | | | | |
| Comp. | 40 | — | — | — | — | — | — | — | — |
| Ex. | | | | | | | | | |

| | polyethylene | | | | | | | |
|---|---|---|---|---|---|---|---|---|
| | glycol | | | | | acetylene | | |
| | thermal | | | | | glycol-based | | |
| | decomposition | drying | | | | compound | | |
| | starting | suppressant | | | | SURFYNOL | OLFINE | |
| | temperature | | amount | | amount | 104PG50 | EXP4036 | water |
| | [° C.] | kind | [wt %] | kind | [wt %] | [wt %] | [wt %] | [wt %] |
| Ex. 1 | — | XY | 6 | PD | 5 | 0.02 | 0.006 | 38.974 |
| Ex. 2 | — | XY | 6 | PD | 5 | 0.02 | 0.006 | 43.974 |
| Ex. 3 | — | XY | 6 | PD | 5 | 0.02 | 0.006 | 41.974 |
| Ex. 4 | — | XY | 6 | PD | 5 | 0.02 | 0.006 | 33.974 |
| Ex. 5 | — | XY | 6 | PD | 5 | 0.02 | 0.006 | 28.974 |
| Ex. 6 | — | XY | 6 | PD | 5 | 0.02 | 0.006 | 38.974 |
| Ex. 7 | — | XY | 6 | PD | 5 | 0.02 | 0.006 | 38.974 |
| Ex. 8 | — | XY | 6 | PD | 5 | 0.02 | 0.006 | 38.974 |
| Ex. 9 | — | XY | 9 | MT | 1.5 | 0.02 | 0.006 | 39.474 |
| Ex. 10 | — | SB | 6 | PD | 5 | 0.02 | 0.006 | 38.974 |
| Ex. 11 | — | ER | 6 | MT | 5 | 0.02 | 0.006 | 38.974 |
| Ex. 12 | — | XY | 6 | GR | 5 | 0.02 | 0.006 | 38.974 |
| Ex. 13 | — | XY | 6 | PD | 5 | 0.02 | 0.006 | 38.974 |
| Ex. 14 | — | XY | 6 | PD | 5 | 0.02 | 0.006 | 28.974 |
| Ex. 15 | 250 | XY | 6 | PD | 5 | 0.02 | 0.006 | 38.974 |
| Ex. 16 | 250 | XY | 6 | PD | 5 | 0.02 | 0.006 | 28.974 |
| Ex. 17 | — | XY | 6 | PD | 5 | 0.02 | 0.006 | 43.974 |
| Ex. 18 | 250 | XY | 6 | PD | 5 | 0.02 | 0.006 | 43.974 |
| Comp. | — | XY | 6 | PD | 5 | 0.02 | 0.006 | 48.974 |
| Ex. | | | | | | | | |

[2] Production of Ceramic Green Sheet

A ceramic green sheet was produced in the following manner. Ceramic powder consisting of alumina (Al₂O₃) and titanium oxide (TiO₂) each having an average particle size of about 1 to 2 μm and glass powder consisting of boron silicate glass having an average particle size of about 1 to 2 μm were mixed with each other in a weight ratio of 1:1.

Polyvinylbutyral having a thermal decomposition starting temperature of 310° C. as a binder and dibutylphthalate as a plasticizer were added to the ceramic powder and the glass powder to obtain a mixture. Surry was obtained by mixing and stirring the mixture. The slurry thus obtained was coated on a PET film in a sheet shape using a doctor blade, to produce a ceramic green sheet. The ceramic green sheet was cut into square sheets whose one side had a length of 200 mm.

[3] Production and Evaluation of Wiring Substrate

Using the conductive pattern formation inks of the Examples 1 to 18 and the Comparative Example, wiring substrates were formed. In this regard, it is to be noted that 20 wiring substrates were formed for each of the conductive pattern formation inks.

Each wiring substrate was formed as follows. First, the conductive pattern formation ink was loaded to the ink jet apparatus as shown in FIGS. 4 and 5. Then, the ceramic green sheet was heated to 60° C. and maintained at that temperature.

Liquid droplets each having a weight of 15 ng per a liquid droplet were sequentially ejected toward the ceramic green sheet from the respective ejection nozzles to draw 20 lines (which would be transformed into metal wirings) each having a line width of 50 μm, a thickness of 15 μm and a length of 10.0 cm.

The ceramic green sheet having the lines (pre-patterns) was put into a drying furnace in which the ceramic green sheet was heated, and the lines were dried at 60° C. for 30 minutes. The ceramic green sheet on which the lines were formed in the above manner was referred to as a first ceramic green sheet. In this regard, 20 first ceramic green sheets were formed for each of the conductive pattern formation inks.

Next, 40 through-holes each having a diameter of 100 μm were formed by a mechanical punch on another ceramic green sheet in positions corresponding to opposite ends of the lines. The conductive pattern formation ink was filled into the 40 through-holes to form cylindrical portions which would be transformed into contacts (vias).

Using the conductive pattern formation ink, square patterns of 2 mm in side length were formed on the cylindrical portions using the ink jet apparatus. These square patterns would be transformed into terminal portions. The ceramic green sheet on which the square patterns were formed in the above manner was referred to as a second ceramic green sheet. In this regard, 20 second ceramic green sheets were formed for each of the conductive pattern formation inks.

Next, a green laminated body was obtained by laminating the first ceramic green sheet below the second ceramic green sheet and then laminating two raw ceramic green sheets therebelow as reinforcing layers. In this regard, 20 green laminated bodies were formed for each of the conductive pattern formation inks.

Subsequently, the green laminated body was pressed at a temperature of 95° C. under a pressure of 250 kg/cm² for 30 seconds. Thereafter, the green laminated body was fired in the atmosphere, according to a firing profile having a temperature elevation process in which the green laminated body was continuously heated for about 6 hours at a heating speed of 66° C./hour, for about 5 hours at a heating speed of 10° C./hour and for about 4 hours at a heating speed of 85° C./hour, and a temperature constant process in which the green laminated body was maintained for 30 minutes at a maximum temperature of 890° C.

By doing so, the lines were transformed in to the metal wirings, the cylindrical portions were transformed into the contacts, the square patterns were transformed into the terminal portions, and the ceramic green sheets were transformed into the ceramic substrates. In this way, the wiring substrate was obtained.

After the wiring substrate had been cooled, a tester was attached between a pair of the terminal portions connected to the 20 metal wirings, in order to confirm whether the respective metal wirings were disconnected or not. Thereafter, conductivity percentage was calculated.

In this regard, it is to be noted that the term “conductivity percentage” shows a value calculated by dividing the number of the accepted metal wirings which are not disconnected by the total number of the metal wirings This result of confirmation are collectively shown in Table 2.

TABLE 2

| | conductivity |
|---|---|
| | percentage |
| Ex. 1 | 100 |
| Ex. 2 | 75 |
| Ex. 3 | 95 |
| Ex. 4 | 100 |
| Ex. 5 | 100 |
| Ex. 6 | 90 |
| Ex. 7 | 100 |
| Ex. 8 | 100 |
| Ex. 9 | 100 |
| Ex. 10 | 100 |
| Ex. 11 | 100 |
| Ex. 12 | 100 |
| Ex. 13 | 75 |
| Ex. 14 | 80 |
| Ex. 15 | 80 |
| Ex. 16 | 85 |
| Ex. 17 | 85 |
| Ex. 18 | 90 |
| Comp. Ex. | 0 |

As shown in Table 2, in the metal wirings (conductive patterns) formed using each of the conductive pattern formation inks of the present invention, a rate of occurrence of disconnection thereof was low, namely, conductivity percentage thereof was high. Therefore, the metal wirings formed using the conductive pattern formation inks of the present invention had high reliability.

Further, the same results as those noted above were attained in the case where the amount of the silver colloid particles contained in the conductive pattern formation ink was changed to 20 wt % and 30 wt %.

What is claimed is:

1. A conductive pattern formation ink for forming a conductive pattern on a sheet-like ceramic sintered body, wherein the ceramic sintered body with the conductive pattern is produced by the steps of: applying the ink onto a sheet-like ceramic molded body made of a material containing ceramic particles and a binder, which will be transformed into the ceramic sintered body, to obtain a pre-pattern which will be transformed into the conductive pattern on the ceramic molded body; and subjecting the ceramic molded body with the pre-pattern to a degreasing and sintering treatment so that the ceramic molded body is transformed into the ceramic sintered body and the pre-pattern is transformed into the conductive pattern, the ink comprising:
a water-based dispersion medium;
metal particles dispersed in the water-based dispersion medium; and
a disconnection preventive agent composed of an organic matter and contained in the water-based dispersion medium, the disconnection preventive agent having a function of providing such a property that the pre-pattern can be deformed according to thermal expansion of the ceramic molded body due to the degreasing and sintering treatment to the pre-pattern, to thereby prevent occurrence of disconnection of the conductive pattern.

2. The conductive pattern formation ink as claimed in claim 1, wherein in the case where a thermal decomposition starting temperature of the organic matter is defined as T₁ [° C.] and a thermal decomposition starting temperature of the binder is defined as T₂ [° C.], the T₁ and T₂ satisfy a relation of −150≦T₁−T₂≦50.

3. The conductive pattern formation ink as claimed in claim 1, wherein the organic matter comprises a polyglycerin compound having a polyglycerin chemical structure.

4. The conductive pattern formation ink as claimed in claim 3, wherein a weight average molecular weight of the polyglycerin compound is in the range of 300 to 3000.

5. The conductive pattern formation ink as claimed in claim 1, wherein an amount of the organic matter contained in the ink is in the range of 7 to 30 wt %.

6. The conductive pattern formation ink as claimed in claim 1, wherein the pre-pattern is formed using a liquid droplet ejecting method.

7. A conductive pattern formed by the conductive pattern formation ink defined by claim 1.

8. A wiring substrate provided with the conductive pattern defined by claim 7.
